(19) United States
(12) Patent Application Publication
(10) Pub. No.: US 2006/0176265 A1
(43) Pub. Date: Aug. 10, 2006

(54) Display device and method of driving the same

(76) Inventors: Tae-Sung Kim, Suwon-si (KR); Seung-Hwan Moon, Yongin-si (KR); Dong-Gyu Kim, Yongin-si (KR); Sang-Soo Kim, Seoul (KR)

Correspondence Address: CANTOR COLBURN, LLP, 55 GRIFFIN ROAD SOUTH, BLOOMFIELD, CT, 06002, US

(21) Appl. No.: 11/349,361

(22) Filed: Feb. 6, 2006

(30) Foreign Application Priority Data
Feb. 4, 2005 (KR) 10-2005-0010605

(51) Int. Cl. G09G 3/36

(52) U.S. Cl. 345/100

(57) ABSTRACT

A display device includes a plurality of pixels that are arranged in a matrix, each pixel having a first subpixel and a second subpixel, a plurality of first gate lines connected to the first subpixels to transmit gate-on voltages to the first subpixels, a plurality of second gate lines connected to the second subpixels to transmit gate-on voltages to the second subpixels, a plurality of data lines that intersect the first and second gate lines and connected to the first and second subpixels to transmit data voltages to the first and second subpixels, a gate driver that supplies the gate-on voltages to the first and second gate lines, and a data driver that supplies the data voltages to the data lines.

This application claims priority to Korean Patent Application No. 10-2005-0010605, filed on Feb. 4, 2005 and all the benefits accruing therefrom under 35 U.S.C. §119, and the contents of which in its entirety are herein incorporated by reference.

### BACKGROUND OF THE INVENTION

(a) Field of the Invention

The present invention relates generally to a display device and a method of driving the same, and more particularly to a display device that is capable of charging pixels sufficiently and efficiently.

(b) Description of the Related Art

Liquid crystal displays (“LCDs”) are the most widely used among flat panel display devices. Generally, an LCD includes a pair of panels each having electrodes on their inner facing surfaces, and a liquid crystal (“LC”) layer having dielectric anisotropy interposed between the panels. In an LCD, varying the voltage difference between the field generating electrodes, i.e., varying the strength of an electric field generated by the electrodes, changes the transmittance of light passing through the LCD. Accordingly, desired images are obtained by controlling the voltage difference between the electrodes on the opposing panels.

A vertical alignment (“VA”) mode LCD aligns long axes of LC molecules in the LC layer perpendicular to the surfaces of the panels when no electric field is applied to the LC layer. The use of a VA mode LCD in flat panel display devices has attracted much attention due to its high contrast ratio and wide standard viewing angle. Here, the standard viewing angle means a viewing angle with a contrast ratio of 1:10 or a critical angle of luminance conversion between gray scales.

Several techniques for enlarging the viewing angle have been used in the VA mode LCDs. One technique includes forming apertures in the field generating electrodes. Another includes forming projections on the field generating electrodes. In both techniques, the LC molecules interposed between the field generating electrodes tilt in certain directions due to the apertures and the projections that serve as elements for determining tilt directions of the LC molecules, thus widening the standard viewing angle.

However, a drawback of the VA mode LCD includes an inferior visibility at both sides of a screen compared to visibility at the front center of the screen. For example, in a patterned vertically alignment (“PVA”) mode LCD with an aperture pattern that is formed in the field generating electrodes, images become brighter as a viewing point moves to either side of the screen from the front center. In the extreme, the difference of luminance between high grayscales may disappear. In this case, the images become very dull.

There is a method to overcome such a drawback. In the method, each pixel is partitioned into two subpixels that are capacitively coupled. One subpixel is supplied with a voltage directly, while the other subpixel is supplied with a lower voltage due to capacitive coupling. That is, the two subpixels are supplied with different voltages, resulting in different transmittances of light passing through them.

However, it is very difficult to precisely control the transmittances of the two subpixels. In addition, since the transmittance of light must be varied depending on the desired color, controlling the voltages of the two subpixels to express a desired color image is impossible. In addition, conductive wiring that is used for the conductive coupling of the two subpixels reduces the aperture ratio, and a lowering of voltage caused by the capacitive coupling reduces the transmittance.

### BRIEF SUMMARY OF THE INVENTION

The present invention provides an improved display device that is capable of charging pixels sufficiently and efficiently.

According to exemplary embodiments of the present invention, a display device includes a plurality of pixels that are arranged in a matrix, each pixel having a first subpixel and a second subpixel, a plurality of first gate lines that are connected to the first subpixels to transmit first gate-on voltages to the first subpixels, a plurality of second gate lines that are connected to the second subpixels to transmit second gate-on voltages to the second subpixels, a plurality of data lines that intersect the first and second gate lines and are connected to the first and second subpixels to transmit data voltages to the first and second subpixels, a gate driver that supplies the first and second gate-on voltages to the first and second gate lines, and a data driver that supplies the data voltages to the data lines.

In this structure, the first subpixel and the second subpixel of each pixel are individually supplied with a first data voltage and a second data voltage different from the first data voltage that are obtained from an input image signal.

The date driver simultaneously supplies the first and second gate-on voltages to the first gate line and the second gate line.

The duration of the first gate-on voltage applied to each first gate line is shorter than the duration of the second gate-on voltage applied to each second gate line.

The device may further include a signal controller that controls the gate driver and the data driver. The signal controller may supply a plurality of vertical synchronizing start signals, which inform the gate driver of the start of output of the gate-on signals. The signal controller may also supply a first output enable signal and a second output enable signal to the gate driver. The first output enable signal and second output enable signal define the duration of the first gate-on voltage applied to each first gate line and each second gate line, respectively.

The gate driver may include a first part that is connected to the first gate lines and a second part that is connected to the second gate lines. The first output enable signal and the second output enable signal may be applied to the first part and the second part, respectively.

A first vertical synchronizing start signal and a second vertical synchronizing start signal, which are individually applied to the first part and the second part of the gate driver, respectively. may be included in the vertical synchronizing start signals.

After selecting gray voltages from a first gray voltage group and a second gray voltage group that are different from each other, based on one input image signal, the data driver may supply the selected gray voltages to the data lines as the data voltages.

According to other exemplary embodiments of the present invention, a method of operating the above-mentioned display device includes applying the first data voltage to the data lines, applying the first gate-on voltage and the second gate-on voltage to the first gate line and the second gate line, respectively, at the same time so that the first data voltage is applied to the first pixels and the second pixels in a pixel row through the data lines, stopping the application of the first gate-on voltage, and applying the second data voltage to the data lines.

The method may further include generating a first gray voltage group and a second gray voltage group, receiving an input image signal, selecting a gray voltage corresponding to the input image signal from the first gray voltage group as the first data voltage, and selecting a gray voltage corresponding to the input image signal from the second gray voltage group as the second data voltage.

In the above-mentioned display device and driving method, the first data voltage and the second data voltage applied to one pixel may have the same polarity. However, polarities of the first data voltage and the second data voltage applied to one pixel may be opposite to those of the first data voltage and the second data voltage applied to another pixel that is adjacent thereto.

The first data voltage applied to the first subpixels may be smaller than the second data voltage applied to the second subpixels.

The duration of the first gate-on voltage applied to the first gate line may be 50% or more of the duration of the second gate-on voltage applied to the second gate line, and particularly, the duration of the first gate-on voltage applied to the first gate line may be between 60% and 70% of the duration of the second gate-on voltage applied to the second gate line.

### BRIEF DESCRIPTION OF THE DRAWINGS

The above objects and other advantages of the present invention will become more apparent by the description of the exemplary embodiments in more detail below with reference to the accompanying drawings.

FIG. 1 is a block diagram of an exemplary embodiment of an LCD according to the present invention.

FIG. 2 is an equivalent schematic circuit of an exemplary embodiment of a pixel of an LCD according to the present invention.

FIG. 3 is a graph showing gamma curves of two subpixels that form a pixel and a gamma curve of the relative pixel.

FIG. 4 is a timing chart of signals of an exemplary embodiment of an LCD according to the present invention.

FIG. 5A is a timing chart of signals showing the durations of two gate-on voltages that are individually applied to two subpixels of a pixel that is positioned in an m-th row of a matrix of pixels employed in an exemplary embodiment of an LCD according to the present invention.

FIG. 5B is a timing chart of signals showing the durations of two gate-on voltages that are individually applied to two subpixels of a pixel that is positioned in an m-th row of a matrix of pixels employed in a typical prior art LCD.

### DETAILED DESCRIPTION OF THE INVENTION

Exemplary embodiments of the present invention will now be described more fully with reference to the accompanying drawings, in which exemplary embodiments of the invention are shown. The present invention may, however, be embodied in different forms and thus the present invention should not be construed as being limited to the exemplary embodiments set forth herein. Rather, these exemplary embodiments are provided so that this disclosure will be thorough and complete, and will fully convey the scope of the invention to those skilled in the art.

In the drawings, the thickness of the layers, films, and regions are exaggerated for clarity. When an element such as a layer, film, region, or substrate is referred to as being “on” another element, it can be directly on the other element or intervening elements may also be present. As used herein, the term “and/or” includes any and all combinations of one or more of the associated listed items.

Hereinafter, an LCD according to an exemplary embodiment of the present invention will be described in detail with reference to the accompanying drawings.

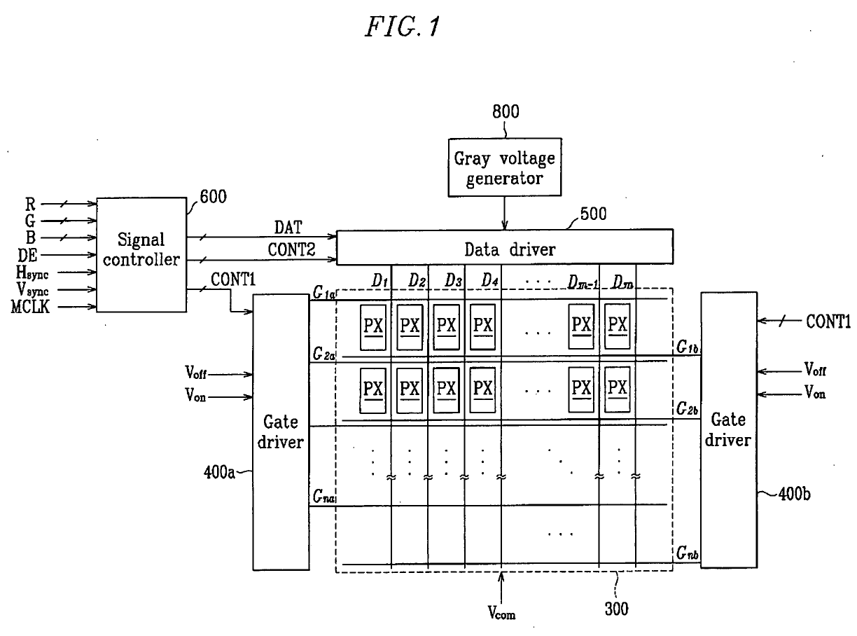

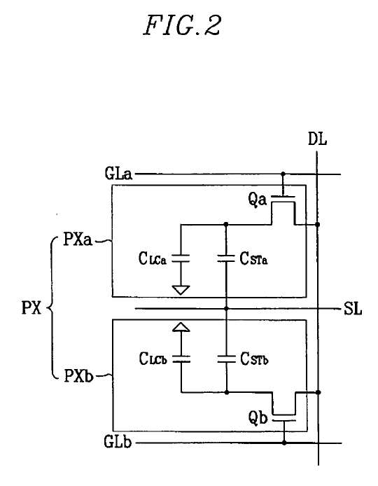

FIG. 1 is a block diagram of an LCD according to an exemplary embodiment of the present invention. FIG. 2 is an equivalent schematic circuit of an exemplary embodiment of a pixel of an LCD according to the present invention.

Referring to FIG. 1, an LCD according to an exemplary embodiment of the present invention comprises an LC panel assembly 300, two gate drivers 400a and 400b connected to the LC panel assembly 300, a data driver 500 connected to the LC panel assembly 300, a gray voltage generator 800 connected to the data driver 500 and a signal controller 600 for controlling the above elements.

The LC panel assembly 300 includes a lower panel (not shown) with a plurality of display signal lines and a plurality of pixels PX connected to the display signal lines and are arranged substantially in a matrix, an upper panel (not shown) positioned opposite to the lower panel, and an LC layer (not shown)interposed between the lower panel and the upper panel.

The display signal lines, which are provided on a substrate of the lower panel, include a plurality of gate lines G₁ₐ-G_{nb} for transmitting gate signals (also referred to as “scanning signals”) and a plurality of data lines D₁-Dₘ for transmitting data signals. The gate lines G₁ₐ-G_{nb} extend substantially in a row direction and are substantially parallel to each other, while the data lines D₁-Dₘ extend substantially in a column direction and are substantially parallel to each other.

Referring to FIG. 2, the display signal lines further include a plurality of storage electrode lines SL, in addition to the gate lines (denoted by GLa and GLb, or GL) and the data lines (denoted by DL). Each storage electrode line SL extends parallel to the gate lines.

Each pixel PX is comprised of a first subpixel PXa and a second subpixel PXb. The first subpixel PXa includes a switching element Qa connected to the gate line GLa and the data line DL, an LC capacitor C_{LCa} connected to the switching element Qa, and a storage capacitor C_{STa} connected to the switching element Qa and the storage electrode line SL. The second subpixel PXb includes a switching element Qb connected to the gate line GLb and the data line DL, an LC capacitor C_{LCb} connected to the switching element Qb, and a storage capacitor C_{STb} connected to the switching element Qb and the storage electrode line SL. The storage capacitors C_{STa} and C_{STb} may be omitted, and if so, the storage electrode line SL may also be omitted.

Referring back to FIG. 1 again, the first and second gate drivers 400a and 400b, which are placed at the left and right, respectively, of the LC panel assembly 300, are connected to the odd-numbered gate lines G₁ₐ-Gₙₐ and the even-numbered gate lines G_{1b}-G_{nb}, respectively, and supply gate signals, consisting of combinations of a gate-on voltage Vₒₙ and a gate-off voltage V_{off} that are input from an external device, to the gate signal lines G₁ₐ-Gₙₐ and G_{1b}-G_{nb}, respectively.

Alternatively, the first and second gate drivers 400a and 400b may be composed of one and placed at one side of the LC panel assembly 300.

The gray voltage generator 800 generates two groups of gray voltages related to the transmittance of the pixels. Each group consists of the gray voltages with positive and negative values based on a common voltage V_{com}. The gray voltages of one group are applied to the first pixels PXa, while the gray voltages of the other group are applied to the second subpixels PXb. Alternatively, the gray voltage generator 800 may generate only one group of the gray voltages.

The data driver 500, which is connected to the data lines D₁-Dₘ of the LC panel assembly 300, selects only one group of the two gray voltage groups supplied from the gray voltage generator 800, and transmits one of the gray voltages in the selected group to the pixel PX as a data signal.

The first and second gate drivers 400a and 400b, respectively, or the data driver 500 may be directly mounted on the LC panel assembly 300 in the form of a plurality of IC chips, or may be mounted on flexible printed circuit films (not shown) that are attached to the LC panel assembly 300, in the form of tape carrier packages (“TCPs”). Otherwise, they may be integrated into the lower panel of the LC panel assembly 300, along with the display signal lines G₁ₐ-G_{nb} and D₁-Dₘ and the TFTs such as the switching elements Qa and Qb.

Hereinafter, the operation of the above-mentioned LCD will be described in more detail.

Referring again to FIG. 1, the signal controller 600 receives image signals R, G, and B and control signals for controlling the display thereof, such as a vertical synchronizing signal V_{sync}, a horizontal synchronizing signal H_{sync}, a main clock signal MCLK, a data enable signal DE, etc., from an external graphics controller (not shown). The signal controller 600 converts the input image signals R, G and B into image data DAT suitable for the operation conditions of the LC panel assembly 300, on the basis of the input control signals and the input image signals R, G and B, and generates gate control signals CONT1 and data control signals CONT2. Then, the signal controller 600 applies the gate control signals CONT1 to the first and second gate drivers 400a and 400b, and the data control signals CONT2 and the image data DAT to the data driver 500.

The gate control signals CONT1 include a vertical synchronizing start signal STV for informing output of a gate-on voltage Vₒₙ, a gate clock signal CPV for controlling the output time of the gate-on voltage Vₒₙ and an output enable signal OE for controlling the duration of the gate-on voltage Vₒₙ.

The data control signals CONT2 include a horizontal synchronizing start signal STH for informing of the beginning of data transmission for a packet of pixels PX, a load signal LOAD for instructing to apply the corresponding data voltages to the data lines D₁-Dₘ, and a data clock signal HCLK. A reverse signal RVS for reversing polarities of the data voltages based on the common voltage V_{com} may be further included in the data control signals CONT2. Hereinafter, the polarity of a data voltage based on the common voltage V_{com} will be referred to as the polarity of a data voltage.

In accordance with the data control signals CONT2 from the signal controller 600, the data driver 500 is supplied with the image data DAT for a packet of pixels from the signal controller 600, and selects one gray voltage group corresponding to the image data DAT from two gray voltage groups that are supplied from the gray voltage generator 800. Then, the data driver 500 selects the related gray voltages corresponding to the image data DAT from the selected gray voltage group of the two gray voltage groups, converts the image data DAT into the data voltages on the basis of the selected gray voltages and applies the data voltages to the corresponding data lines D₁-Dₘ.

Alternatively, the data driver 500 may be supplied with one group of gray voltages selected by an external selection circuit that is separately provided.

In response to the gate control signals CONT1 from the signal controller 600, the first and second gate drivers 400a and 400b apply the gate-on voltages Vₒₙ₁ and Vₒₙ₂ (not shown) to the odd-numbered gate lines G₁ₐ-Gₙₐ and the even-numbered gate lines G_{1b}-G_{nb}, respectively, thereby turning on the switching elements Qa and Qb connected thereto. Accordingly, the data voltages V_{d} (not shown), which are applied to the data lines D₁-Dₘ, are applied to the first subpixel PXa and the second subpixel PXb through the activated switching elements Qa and Qb.

The differences between the data voltages V_{d} applied to the two subpixels PXa and PXb and the common voltage V_{com} are represented as charging voltages across the corresponding LC capacitors C_{LC}a and C_{LC}b, namely, subpixel voltages of the first and second subpixels PXa and PXb or a pixel voltage of the pixel PX. LC molecules in the LC layer have orientations depending on the magnitude of the pixel voltage, and the orientations of the LC molecules determine the polarization of light passing through the LC layer, as discussed above.

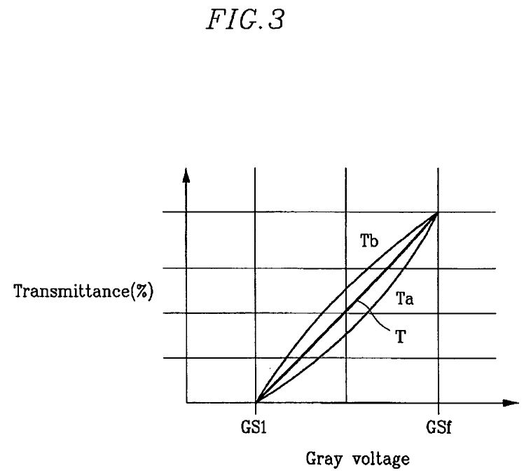

FIG. 3 is a graph showing three gamma curves Ta, Tb and T Here, the curves Ta and Tb are gamma curves of the subpixel PXa and PXb, respectively, to which two gray voltage groups are individually applied. Since the pixel PX consists of the first and second subpixels PXa and PXb, a gamma curve (not shown) of the pixel PX is obtained by averaging the two gamma curves Ta and Tb. The two gray voltage groups are preprogrammed so that the gamma curve of the pixel PX approaches a target gamma curve T at the front. For example, the two gray voltage groups are pre-programmed so that the gamma curve T at the front coincides with the target gamma curve T and the gamma curve of the pixel PX at the side approaches the target gamma curve as closely as possible. The target gamma curve T may be designed according to specific character of a device.

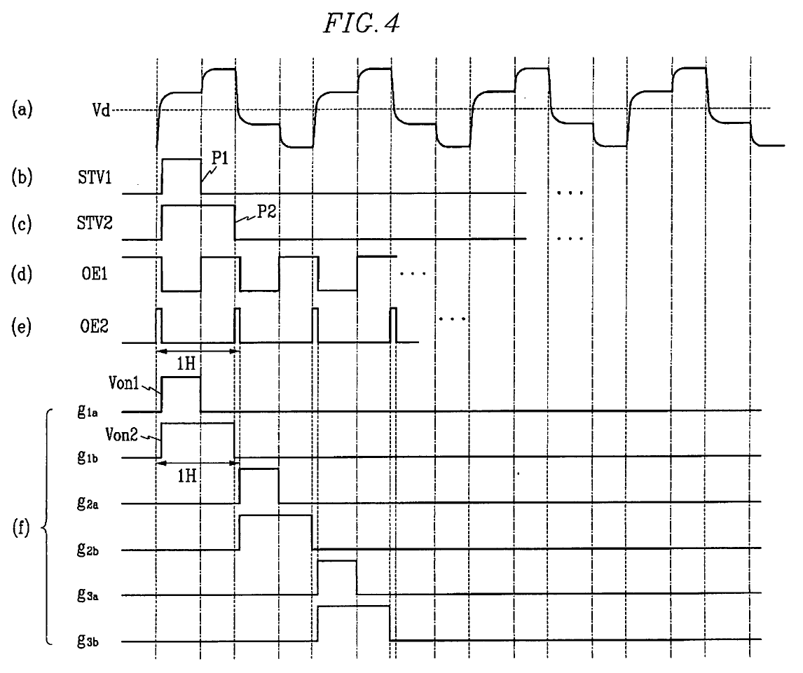

As shown in FIG. 1, the data driver 500 and the first and second gate drivers 400a and 400b repeat the above-mentioned operations by a unit of a half of a horizontal period (which is denoted by “½ H” and is equal to one period of the horizontal synchronizing signal H_{sync} and the gate clock CPV). Since the number of gate lines employed in this LCD is twice that of a typical LCD, the pixel charging time is relatively reduced. Hereinafter, a method of compensating the reduced pixel charging time will be described with reference to FIG. 4.

FIG. 4 is a timing chart showing waveforms of signals of the LCD. In FIG. 4, V_{d} is a data voltage flowing along the data line, STV1 and STV2 are vertical synchronizing start signals, OE1 and OE2 are output enable signals, and g1a, g1b, g2a, g2b, g3a and g3b are gate signals that are applied to the gate lines. In this LCD, the polarity of the data voltage V_{d} is reversed per consecutive pixel or per consecutive pixel row.

Referring again to FIG. 1, the first gate driver 400a positioned at the left of the LC panel assembly 300 outputs a gate-on voltage Vₒₙ₁ to the odd-numbered gate lines G1a, G2a, G3a, . . . , Gₙₐ connected to the output terminal of the first gate driver 400a, while the second gate driver 400b positioned at the left of the LC panel assembly 300 outputs a gate-on voltage Vₒₙ₂ to the even-numbered gate lines G1b, G2b, G3b, . . . , G_{nb} connected to the output terminal of the second gate driver 400b. The durations of the two gate-on voltages Vₒₙ₁ and Vₒₙ₂ are different from each other, but the two voltages Vₒₙ₁ and Vₒₙ₂ overlap each other for a predetermined duration after being outputted at the same time from the gate drivers 400a and 400b. Here, the overlap time of the voltages Vₒₙ₁ and Vₒₙ₂ is 50% or more of the non-overlap time thereof. In this exemplary embodiment, each duration of the two gate-on voltages Vₒₙ₁ and Vₒₙ₂ is less than 1 H.

Still referring to FIG. 1 in conjunction with FIG. 4, the signal controller 600 applies the vertical synchronizing start signals STV1 and STV2 to the first and second gate drivers 400a and 400b so that the first and second gate drivers 400a and 400b output the gate-on voltages Vₒₙ₁ and Vₒₙ₂, respectively, in response to the signals STV1 and STV2.

Also, the signal controller 600 applies the output enable signals OE1 and OE2, which define the durations of the gate-on voltages Vₒₙ₁ and Vₒₙ₂, to the first and second gate drivers 400a and 400b. Referring to FIG. 4 when the output enable signal OE1 applied to the first gate driver 400a is high, the output of the gate-on voltage Vₒₙ₁ is controlled. A gate-off voltage V_{off1} is outputted from the gate driver 400a. Similarly, when the output enable signal OE2 applied to the second gate driver 400b is high, the second gate driver 400b outputs a gate-off voltage V_{off2} instead of the gate-on voltage Vₒₙ₂. On the contrary, when the output enable signals OE1 and OE2 are low, the first and second gate drivers 400a and 400b output the gate-on voltages Vₒₙ₁ and Vₒₙ₂, respectively. However, the gate-on voltages and the gate-off voltages may be conversely outputted. The gate signals g₁ₐ-g_{nb} are applied to the respective gate lines G₁ₐ-G_{nb} as follows.

The signal controller 600 generates the vertical synchronizing start signals STV1 and STV2 with pulses P1 and P2 as shown in (b) and (c), respectively, of FIG. 4, and the output enable signals OE1 and OE2 exhibiting waveforms as shown in (d) and (e), respectively, of FIG. 4.

When the pulse P1 of the vertical synchronizing start signal STV1 is applied to the first gate driver 400a, the odd-numbered gate lines G₁ₐ, G₂ₐ . . . Gₙₐ connected to the first gate driver 400a sequentially output the gate-on voltages Vₒₙ₁ with a first duration defined by the output enable signal OE1. Meanwhile, when the pulse P2 of the vertical synchronizing start signal STV2 is applied to the second gate driver 400b, the even-numbered gate lines G_{1b}, G_{2b} . . . G_{nb} connected to the second gate driver 400b sequentially output the gate-on voltages Vₒₙ₂ with a second duration defined by the output enable signal OE2.

Here, since the vertical synchronizing start signals STV1 and STV2 are individually applied to the first and second gate drivers 400a and 400b at the same time, the output of the gate-on voltages Vₒₙ₁ and Vₒₙ₂ is generated in response to the vertical synchronizing start signals STV1 and STV2, starting from the gate lines G₁ₐ and G_{1b} that are individually connected to the first-positioned output terminals of the first and second gate drivers 400a and 400b, as shown in (f) of FIG. 4.

While the gate-on voltages Vₒₙ₁ and Vₒₙ₂ are overlapped with each other, the first and second subpixels PXa and PXb of the first pixel row are charged with the data voltage V_{d} for the first subpixel PXa, as shown in (a) of FIG. 4. That is, a main charging of the first subpixel PXa and a pre-charging of the second subpixel PXb are carried out with the data voltage V_{d} for the first subpixel PXa.

As mentioned above, the data voltage V_{d} for the first subpixel PXa and the data voltages V_{d} for the second subpixel PXb are obtained by converting any one of the image signals R, G and B, based on the gray voltages selected from two gray voltage groups that are set on the basis of the corresponding gamma curves Ta and Tb. Accordingly, the data voltage V_{d} applied to the first subpixel PXa has a value that is close to a value of the data voltage V_{d} applied to the second subpixel PXb, and the polarities of the two data voltages V_{d} are also the same. In the present invention, the gate-on voltages Vₒₙ₁ and Vₒₙ₂ are applied to two adjacent gate lines that are each connected to a row of pixels, without a predetermined interval that would ordinarily be provided to prevent an overlap of two voltages Vₒₙ₁ and Vₒₙ₂ caused by delay of signals. This is possible because the second subpixel PXb is supplied with the data voltage V_{d} for second subpixel PXb shortly after being pre-charged with the data voltage V_{d} for the first subpixel PXa. However, a predetermined interval is provided between the gate-on voltages Vₒₙ₁ and Vₒₙ₂ to be applied to the respective gate lines that are individually connected to two adjacent pixel rows to which the data voltages V_{d}, based on different image signals, are applied.

Due to such a structure, with the data voltage V_{d} for the first subpixel PXa applied from the data driver 500, the main charging of the first subpixel PXa and the pre-charging of the second subpixel PXb are performed at the same time. Shortly after the charging of the first subpixel PXa is completed, the main charging of the second subpixel PXb begins and continues for the remaining duration of the first gate-on voltage Vₒₙ₁. In the case where the data voltage V_{d} for the first subpixel PXa is lower than the data voltage V_{d} for the second subpixel PXb, as shown in (a) of FIG. 4, the second subpixel PXb obtains a desired charging voltage through the pre-charging and main charging steps. However, it will be recognized that the data voltage V_{d} for the first subpixel PXa may be higher than the data voltage V_{d} for the second subpixel PXb.

As mentioned above, in 1 H, the overlap time of the gate-on voltages Vₒₙ₁ and Vₒₙ₂ is preferably shorter than the non-overlap time. In other words, the charging time of the first subpixel PXa (or the pre-charging time of the second subpixel PXb) is preferably longer than the main charging time of the second subpixel PXb. This is because the second subpixel PXb can be sufficiently charged even if the main charging time is somewhat short since it is pre-charged during the duration of the first gate-on voltage Vₒₙ₁, while the first subpixel PXa requires sufficient charging time for good charging since it is not pre-charged, differing from the second subpixel PXb. However, the durations of the first and second gate-on voltages Vₒₙ₁ and Vₒₙ₂ can be controlled depending on the charging ratios of the two subpixels PXa and PXb.

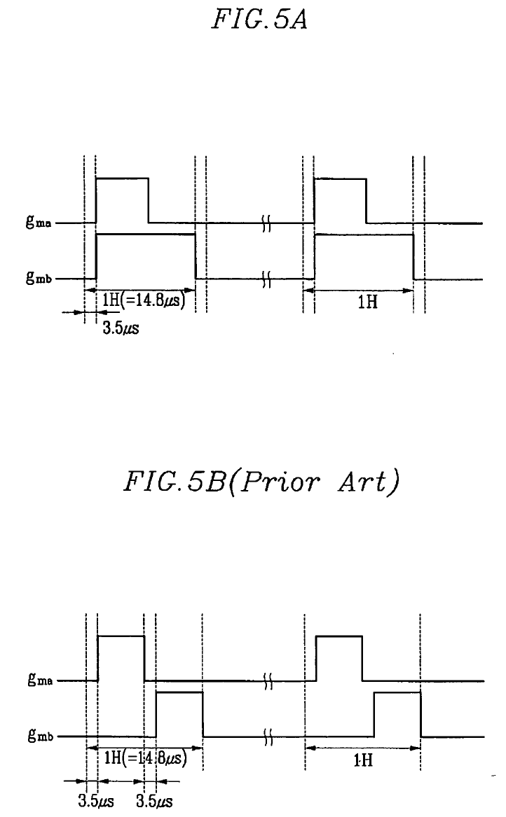

Hereinafter, the time required for charging one pixel PX in the above-mentioned manner will be described with reference to FIGS. 5A and 5B.

FIG. 5A shows durations of gate-on voltages Vₒₙ₁ and Vₒₙ₂ of two gate signals gₘₐ and g_{mb} that are individually applied to two subpixels PXma and PXmb of a pixel PXm included in an m-th pixel row of an exemplary embodiment of an LCD according to the present invention. FIG. 5B shows durations of gate-on voltages Vₒₙ₁ and Vₒₙ₂ of two gate signals gₘₐ and g_{mb} that are individually applied to two subpixels PXma and PXmb of a pixel PXm included in an m-th pixel row of a typical prior art LCD.

When a frequency of a frame is 60 Hz, the charging period of 1 H is about 14.8 μs. In this case, if the duration of the gate-on voltage Vₒₙ₁ is half of the duration of the gate-on voltage Vₒₙ₂ in 1 H, the durations of the gate-on voltages Vₒₙ₁ and Vₒₙ₂ begin with a predetermined time interval from the beginning of 1 H, taking into account a delay of signals. If the predetermined time interval is about 3.5 μs, the duration of the gate-on voltage Vₒₙ₁ becomes 5.65 μs, and the duration of the gate-on voltage Vₒₙ₂ also becomes 5.65 μs.

Differing from FIG. 5A, durations of gate-on voltages Vₒₙ₁ and Vₒₙ₂ of two gate signals gₘₐ and g_{mb} in a typical prior art LCD shown in FIG. 5B, intervals for compensating the signal delay are also given between the two gate-on voltages Vₒₙ₁ and Vₒₙ₂, as well as between the adjacent pixels PX. In this case, each duration of the gate-on voltage Vₒₙ₁ and Vₒₙ₂ becomes 3.9 μs (i.e., 14.1 μs minus 2× (3.5 μs delay)=7.8 μs for duration of both the gate-on voltage Vₒₙ₁ and Vₒₙ₂). However, it should be noted that the above-described numerical descriptions of the above elements are only one example for understanding of the ordinary person skilled in the art, not limited by thereto.

As mentioned above, in the present invention, the charging time of the gate-on voltage Vₒₙ₁ and Vₒₙ₂ becomes longer than those of the typical prior art.

Differing from the above-described embodiment using two gate drivers, only one gate driver alternatively may be used, to which all gate lines are connected. Alternatively, a plurality of integrated circuits may be mounted in such a gate driver. In this case, the integrated circuits may be divided into two groups that are connected to the odd-numbered gate lines and the even-numbered gate lines, respectively.

As mentioned above, in the present invention, two gate-on voltages are simultaneously outputted to the corresponding subpixels and overlap each other for a predetermined time period from the output time. Accordingly, the effective durations of the two gate-on voltages are increased and the charging time of two subpixels is also increased. In addition, since one of the two subpixels is pre-charged with the data voltage based on the same image signal, charging efficiency is improved.

The present invention should not be considered limited to the particular exemplary embodiments described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. A display device comprising:
a plurality of pixels arranged in a matrix, each pixel having a first subpixel and a second subpixel;
a plurality of first gate lines connected to the first subpixels to transmit first gate-on voltages to the first subpixels;
a plurality of second gate lines connected to the second subpixels to transmit second gate-on voltages to the second subpixels;
a plurality of data lines intersecting the first and second gate lines and connected to the first and second subpixels to transmit first and second data voltages to the first and second subpixels, respectively;
a gate driver supplying the first and second gate-on voltages to the first and second gate lines, respectively; and
a data driver supplying the first and second data voltages to the data lines, the first and second data voltages based upon an image data and having different values from each other,
wherein the first gate-on voltage is off earlier than the second gate-on voltage.

2. The device of claim 1, wherein the first subpixel is supplied with the first data voltage during a duration of the first gate-on voltage applied to each first gate line, and
the second subpixel is sequentially supplied with the first and second data voltages during a duration of the second gate-on voltage applied to each second gate line, the second data voltage being supplied to the second subpixel after the first gate-on voltage applied to the first gate line is off.

3. The device of claim 2, wherein the data driver selects gray voltages from a first and second gray voltage groups, and supplies the selected gray voltages in response to the image data to the data lines as the first and second data voltages.

4. The device of claim 2, wherein the duration of the first gate-on voltage is shorter than the duration of the second gate-on voltage.

5. The device of claim 4, wherein the duration of the first gate-on voltage applied to each first gate line is 50% or more of the duration of the second gate-on voltage applied to each second gate line.

6. The device of claim 2, further comprising a signal controller generating first and second synchronizing start signals, the first and second synchronizing start signals controlling the first and second gate-on voltages.

7. The device of claim 6, wherein the signal controller generates first and second output enable signals, the first and second output enable signals controlling the first and second gate-on voltages.

8. The device of claim 2, wherein the gate driver starts to supply the first and second gate-on voltages to each first and second gate line at the same time.

9. The device of claim 2, wherein polarities of the first and second data voltages applied to the first and second subpixels of one pixel are the same.

10. The device of claim 9, wherein the polarities of the first and second data voltages applied to the first and second subpixels of the one pixel are opposite to those of the first and second data voltages applied to the first and second subpixels of another pixel adjacent to the one pixel.

11. The device of claim 1, wherein the gate driver starts to supply the first and second gate-on voltages to each first and second gate line at the same time.

12. The device of claim 10, wherein the first and second data voltages are sequentially supplied to the data line, the second data voltage being supplied to the data line after the first gate-on voltage is off.

13. The device of claim 1, wherein a duration of the first gate-on voltage is shorter than a duration of the second gate-on voltage.

14. The device of claim 13, wherein the duration of the first gate-on voltage applied to each first gate line is 50% or more of the duration of the second gate-on voltage applied to each second gate line.

15. The device of claim 14, wherein the duration of the first gate-on voltage applied to each first gate line is between 60% and 70% of the duration of the second gate-on voltage applied to each second gate line.

16. The device of claim 1, wherein the data driver selects gray voltages from a first and second gray voltage groups having different reference voltages from each other and supplies the selected gray voltages in response to the image data to the data lines as the first and second data voltages.

17. A method of driving a display device that comprises a plurality of pixels arranged in a matrix, each pixel having a first subpixel and a second subpixel, the method comprising:
applying a first gate-on voltage to a first gate line connected to the first subpixel;
applying a second gate-on voltage to a second gate line connected to the second subpixel;
applying a first data voltage to a data line connected to the first and second subpixels;
stopping the application of the first gate-on voltage to the first gate line; and
applying the second data voltage different from the first data voltage to the data line.

18. The method of claim 17, wherein applying the second data voltage to the data line follows stopping the application of the first gate-on voltage to the first gate line.

19. The method of claim 17, further comprising:
generating a first gray voltage group and a second gray voltage group;
receiving an image data;
selecting a first gray voltage corresponding to the image data from the first gray voltage group, as the first data voltage; and
selecting a second gray voltage corresponding to the image data from the second gray voltage group, as the second data voltage.

20. The method of claim 17, wherein a duration of the first gate-on voltage is shorter than a duration of the second gate-on voltage.

21. The method of claim 19, wherein the duration of the first gate-on voltage applied to the first gate line is 50% or more of the duration of the second gate-on voltage applied to the second gate line.

22. The method of claim 17, wherein polarities of the first and second data voltages of the first and second subpixels of one pixel are the same.

23. The method of claim 22, wherein the polarities of the first and second data voltages applied to the first and second subpixels of the one pixel are opposite to those of the first and second data voltages applied to the first and second subpixels of another pixel adjacent to the one pixel.

24. The method of claim 17, further comprising receiving first and second synchronizing start signals, the first and second synchronizing start signals controlling the first and second gate-on voltages.

25. The method of claim 17, further comprising receiving first and second output enable signals, the first and second output enable signals controlling the first and second gate-on voltages.
